(19) United States
(12) Patent Application Publication
(10) Pub. No.: US 2026/0062146 A1
(43) Pub. Date: Mar. 5, 2026

(54) LANDING GEAR WITH ELECTRICAL ENERGY RECEIVER FOR MOVING AN AIRCRAFT DURING TAXIING

(71) Applicant: Airbus SAS, BLAGNAC (FR)

(72) Inventors: Francois ROUYRE, BLAGNAC (FR); Didier CHASSAIGNE, BLAGNAC (FR); Olivier CREPEL, BLAGNAC (FR)

(21) Appl. No.: 19/299,920

(22) Filed: Aug. 14, 2025

(30) Foreign Application Priority Data
Aug. 30, 2024 (FR) FR2409259

(51) Int. Cl. B64F 1/35; B64C 25/10; B64C 25/32; B64C 25/36

(52) U.S. Cl. CPC B64F 1/35; B64C 25/10; B64C 25/36; B64C 25/405

(57) ABSTRACT

A landing gear for an aircraft, having a leg and a wheel support, and two wheels secured to the leg by the wheel support, the wheels being spaced apart from each other such that a space, called an internal volume, is delimited between the two wheels, the landing gear also has an electrical energy receiving device, the electrical energy receiving device comprising a receiver, configured to receive electrical energy emitted by a transmitter, the electrical energy receiving device mounted movably between a retracted position and a deployed position, in which the receiver is arranged outside the internal volume, the electrical energy receiving device comprising an end secured to the wheel support.

### CROSS-REFERENCES TO RELATED APPLICATIONS

This application claims the benefit of French Patent Application Number FR2409259 filed on Aug. 30, 2024, the entire disclosure of which is incorporated herein by way of reference.

### FIELD OF THE INVENTION

The present invention relates to a landing gear provided with an electrical energy receiving device for moving an aircraft during taxiing.

### BACKGROUND OF THE INVENTION

Before it takes off or after it lands, an aircraft moves along the ground by travelling along a taxiway of an airport facility between its parking zone and the takeoff and landing runway. This is referred to as taxiing. During this phase, the aircraft uses the thrust generated by its propulsion assemblies.

This solution is not optimal because the aircraft consumes energy in the form of fuel stored in its tanks in order to move along the ground, and this leads to an increase in the fuel consumption and the on-board mass of the aircraft.

The aim of the invention is to at least partially overcome these drawbacks.

### SUMMARY OF THE INVENTION

To this end, there is proposed a landing gear for an aircraft, comprising a leg and a wheel support, and two wheels secured to the leg by the wheel support, the wheels being spaced apart from each other such that a space, called an internal volume, is delimited between the two wheels, the landing gear comprising an electrical energy receiving device, the electrical energy receiving device comprising an electrical energy receiving element, called a receiver, configured to receive electrical energy emitted by an electrical energy emitting element, called a transmitter, arranged at a distance from the landing gear, the electrical energy receiving device being mounted movably between a retracted position and a deployed position, in which the receiver is arranged outside the internal volume, the electrical energy receiving device comprising an end secured to the wheel support.

By virtue of the landing gear according to the present invention, it is possible to electrically power an electric motor for the landing gears of the aircraft, and this makes it possible to avoid having to use the propulsion assemblies of the aircraft and the auxiliary power unit, and thus makes it possible to reduce the on-board mass and the fuel consumption of the aircraft because the latter therefore no longer consumes fuel in order to move along the ground.

One subject of the invention is a landing gear for an aircraft, comprising a leg and a wheel support, and two wheels secured to the leg by the wheel support, the wheels being spaced apart from each other such that a space, called an internal volume, is delimited between the two wheels, the landing gear comprising an electrical energy receiving device, the electrical energy receiving device comprising an electrical energy receiving element, called a receiver, configured to receive electrical energy emitted by an electrical energy emitting element, called a transmitter, wherein the electrical energy receiving device comprises a structure for holding the receiver, the electrical energy receiving device being mounted movably between a retracted position, in which the electrical energy receiving device is arranged in the internal volume, and a deployed position, in which the receiver is arranged outside the internal volume, the electrical energy receiving device comprising an end secured to the wheel support.

According to another aspect, the electrical energy receiving device comprises a structure for holding the receiver.

According to another aspect, the holding structure comprises a fixed part, which has the end of the electrical energy receiving device secured to the wheel support and a part articulated on the fixed part.

According to another aspect, the receiver is secured to an end of the articulated part of the structure.

According to another aspect, the receiver is mounted movably relative to the articulated part of the structure.

According to another aspect, the electrical energy receiving device comprises an actuator for controlling the receiver.

According to another aspect, the receiver comprises an induction pad, for cooperating with the transmitter in a contactless manner and/or a contactor for cooperating with the transmitter by contact.

According to another aspect, the landing gear comprises an electric motor configured to control said wheels of the landing gear of the aircraft and configured to be supplied with electrical energy via the receiver.

Another subject of the invention is an aircraft comprising a landing gear as described above.

Another subject of the invention is an electrical energy transfer system comprising an aircraft as described above and an electrical energy transmitter configured to supply electrical energy to the receiver when the electrical energy receiving device is in the deployed position.

### BRIEF DESCRIPTION OF THE DRAWINGS

Further features, details and advantages will become apparent upon reading the detailed description below, and analyzing the appended drawings, in which:

FIG. 1 is a schematic perspective side view of a front part of an aircraft that may be provided with a landing gear according to the present invention.

FIG. 2 is a schematic perspective view of a detail II in FIG. 1 for positioning an electrical energy receiving device.

FIG. 3 is a side view of a landing gear according to the present invention, in the retracted position.

FIG. 4 is a schematic view of the landing gear in FIG. 3 in the deployed position.

FIG. 5 is a side view of a landing gear according to an embodiment variant of the present invention, in the retracted position.

FIG. 6 is a schematic view of the landing gear in FIG. 5 in the deployed position.

FIG. 7 is a schematic rear view of the landing gear in FIG. 6.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements that, although not explicitly described or depicted here, nevertheless embody the principles of the present invention and are included in its spirit and scope.

Furthermore, for ease of understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and again not to define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

To make the present description easier to read, an orthonormal reference system (X, Y, Z) has been illustrated in the figures. The X direction corresponds to the direction of forward movement of the aircraft and the Z direction to a vertical direction, the aircraft being illustrated during taxiing.

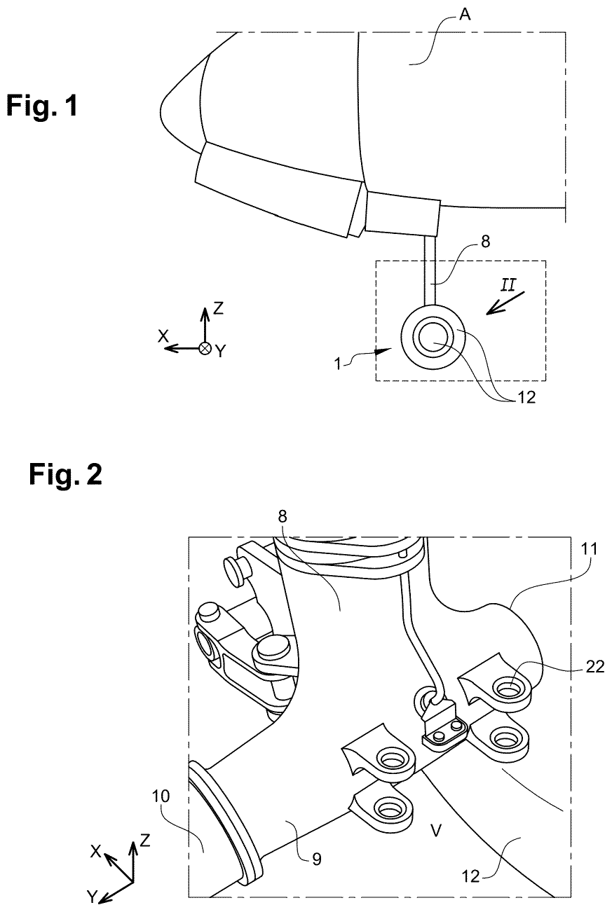

As is evident from FIGS. 1 to 7, one subject of the invention is a landing gear, referenced 1 in the figures. The landing gear 1 comprises an electrical energy receiving device, referenced 2.

As is visible in FIGS. 1 and 2, the landing gear 1 is intended to equip an aircraft A, and another subject of the invention is the aircraft A provided with the landing gear 1.

The electrical energy receiving device 2 comprises an electrical energy receiving element, called a receiver, referenced 4. The receiver 4 is configured to receive electrical energy emitted by an electrical energy receiving element, called a transmitter 5. The transmitter 5 is distinct from the landing gear 1; it does not form part thereof.

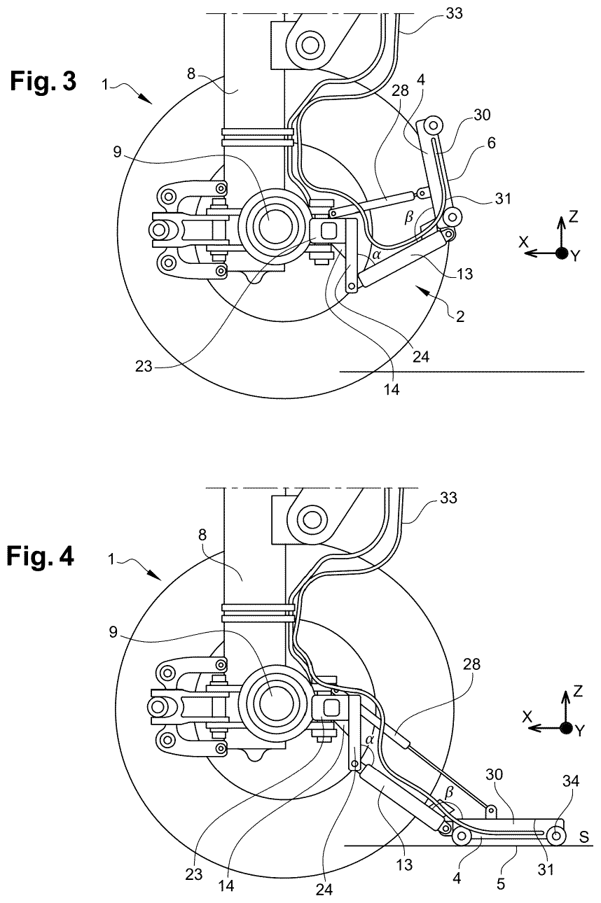

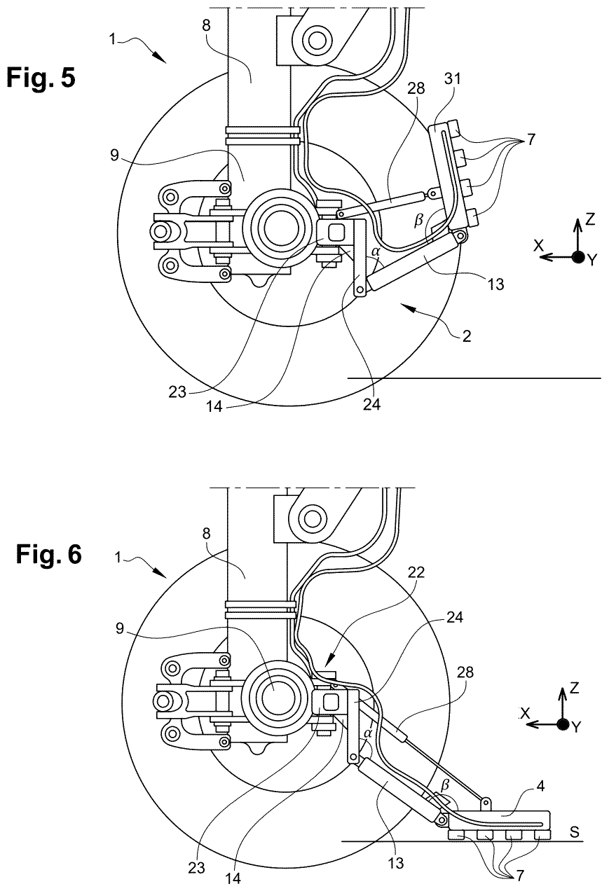

According to a first embodiment variant, illustrated in FIGS. 3 and 4, the receiver 4 takes the form of a pad 6, whereas, according to the second variant, illustrated in FIGS. 5, 6 and 7, the receiver 4 takes the form of a set of contactors 7.

The pad 6 is designed to transfer, in a contactless manner, the electrical energy emitted by the transmitter 5. For example, using inductive technology, the transmitter 5, which is preferably present on the ground S, is configured to generate an electromagnetic field, and the receiver 4/pad 6 is an electromagnetic induction element configured to generate an electric current when it is positioned in the magnetic field generated by the transmitter 5. In this case, the receiver 4/pad 6 comprises at least one coil.

Each contactor 7 is designed to transfer the electrical energy emitted by the transmitter 5 when the contactor 7 is in contact with the transmitter 5 that may, for example, take the form of rails on the ground S.

As is visible in the figures, the device 2 is mounted movably between a retracted position, illustrated in FIGS. 3 and 5, and a deployed position, illustrated in FIGS. 4, 6 and 7, in which the receiver 4 is arranged so as to receive the energy emitted by the transmitting element 5.

As is also evident from the figures, the landing gear 1 comprises a leg 8 secured to the fuselage F of the aircraft A. When the aircraft A is taxiing, the leg 8 extends substantially orthogonal to the ground S. The landing gear 1 also comprises a wheel support 9 extending rectilinearly between two ends 10, 11, each of the ends 10, 11 bearing a wheel 12.

A volume delimited by the space between the two wheels 12 is referred to as internal volume V.

The device 2 is now described.

The device 2 comprises a support 13 for the receiver 4, which is mounted movably, and a structural element, 14, fastened to the wheel support 9.

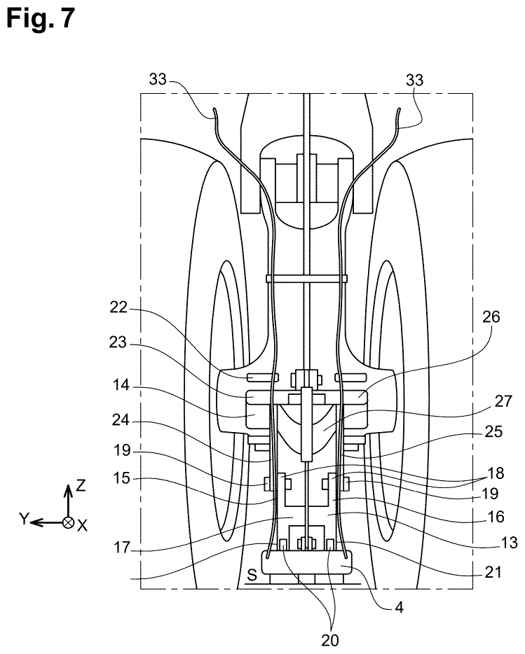

As is more particularly visible in FIG. 7, the support 13 has the overall shape of an H, and advantageously comprises two parallel arms 15, 16, and at least one connecting arm 17 that connects the parallel arms 15, 16 to one another. Each connecting arm 17 is preferably arranged orthogonal to the parallel arms 15, 16. In the embodiment illustrated, and in a non-limiting manner, the support 13 comprises a single connecting arm 17.

Each of the arms 15, 16 extends between a first end 18 secured to the structural element 14 via an articulation 19, for example a pivot connection, and a second end 20 secured to the receiver 4 via an articulation 21, for example a pivot connection.

As is visible in the figures, the structural element 14 is fastened to the wheel support 9 by fastening attachments 22 and articulated to the support 13.

As can be seen in particular in FIG. 7, the structural element 14 comprises a part 23 resting on the wheel support 9 and two parallel bars, 24, 25, which are secured by the articulations 19 to the parallel arms 15, 16 of the support 13. The part 23 advantageously comprises a rectilinear portion 26, forming a bar, and a curved portion 27, forming a bar and spaced apart from the rectilinear portion 26, and this reinforces the structural element 14 while adding as little mass as possible.

An angle delimited by the part 23 and each of the bars 25, 26 is referred to as first articulation angle, referenced α.

The end of each of the bars 25, 26 secured to the support 13 describes an arc of a circle between a first position corresponding to a minimum value of the angle α and a second position corresponding to a maximum value of the angle α. Advantageously, and in a non-limiting manner, the minimum value is less than or equal to 90°, for example between 45° and 90°, for example between 50° and 70°, for example 60°. Advantageously, and in a non-limiting manner, the maximum value is greater than or equal to 90°, for example between 90° and 150°, for example between 110° and 140°, for example 130°.

The first position corresponds to a folded position of the support 13 relative to the structural element 14, while the second position corresponds to an extended position of the support 13 relative to the structural element 14.

The landing gear 1 advantageously comprises a means for driving the support between the folded position and the extended position, for example an actuator, such as a hydraulic or pneumatic actuating cylinder, not illustrated in the figures.

An angle delimited by each of the arms 15, 16 and the receiver 4 is referred to as second articulation angle, referenced β.

The end 21 of each of the arms 15, 16 secured to the receiver 4 describes an arc of a circle between a first position corresponding to a minimum value of the angle β and a second position corresponding to a maximum value of the angle β. Advantageously, and in a non-limiting manner, the minimum value is between 110° and 160°, for example 130°, and the maximum value is between 120° and 170°, for example 160°.

The first position corresponds to a folded position of the receiver 4 relative to the support 13, while the second position corresponds to an extended position of the receiver 4 relative to the support 13.

The landing gear 1 advantageously comprises a means for driving the support between the folded position and the extended position, for example an actuator, such as a hydraulic or pneumatic actuating cylinder, referenced 28 in the figures. The actuator 28 also makes it possible to press the contactors 7 against the ground S, in order to transfer the electrical energy by friction between the transmitter 5 and the contactors 7. The actuator 28 comprises a cylinder 28-1 secured to the wheel support 9, and a rigid rod 28-2 secured by one end to a carriage 30, described in detail below.

When the receiver 4 is in the folded position relative to the support 13, and the support 13 is in the folded position relative to the structural element 14, the electrical energy receiving device 2 is in the retracted position.

When the receiver 4 is in the extended position relative to the support 13, and the support 13 is in the extended position relative to the structural element 14, the electrical energy receiving device 2 is in the deployed position.

In the retracted position, the receiver 4 is contained in the internal volume V until, potentially, it is tangential to the wheels 12. In the deployed position, the receiver 4 is arranged outside the internal volume V, laid against the ground S, and this allows it to cooperate with the transmitter 5 to transfer the electrical energy from the transmitter 5, as already explained.

As is visible in the figures, the device 2 comprises a carriage 30 that bears the receiver 4. The carriage 30 comprises a platform 31 on which the axles of the articulations 21 of the parallel arms 15, 16 are mounted. The carriage 30 is either provided with wheels 32, as in the first variant in FIGS. 3 and 4, or is devoid thereof, as in the second embodiment variant, illustrated in FIGS. 5 to 7.

Advantageously, the landing gear 1 comprises an electric motor (not illustrated), and, potentially, a unit for distributing the electrical energy received by the receiver 4. The landing gear also comprises an electrical cable 33, two in the illustrated embodiment, or electrical wiring harness, for transferring the electrical energy to the aircraft. The electrical energy received by the receiver 4 may be transferred to the electric motor, potentially via the unit, to control the movement of the wheels 12 of the landing gear. The invention is not limited to this configuration and the electrical energy received by the system may be transferred to an electric motor arranged outside of the landing gear 1.

The operation of the landing gear 1, when it equips the aircraft A, is now described.

In the flight phase, the landing gear 1 is in the rest position, in a compartment of the aircraft A, and the device 2 is in the retracted position. In this position, the device 2 adds little mass to the aircraft A, and folding the system between the wheels, in the volume V, makes it possible not to have to adjust the geometry of the hatches of the landing gears or the aerodynamic shape thereof.

In the landing phase, the landing gear 1 is moved out of the compartment, the device 2 remaining in the retracted position, such that it does not affect the movement of the wheels 12.

During taxiing, the device 2 is driven, for example by a control unit, to bring it into the deployed position: the support 13 unfolds, passing from the folded position to the extended position. Then, the actuator 28 pushes the platform 31 against the ground S, and this ensures either a constant distance between the pad 6 and the ground (first variant), or continuous contact between the contactors 7 and the ground (second variant).

Once it is in the deployed position, the device 2 may receive electrical energy from the transmitter 5, either in a contactless manner, or by contact, as explained above.

Conversely, when the aircraft is in position for takeoff, the device 2 is retracted into the internal volume V.

Thus, the landing gear 1, by virtue of the device 2, constitutes a means that is both more ecological and quieter for the movement of the aircraft during taxiing. In particular, by virtue of the device 2, the aircraft no longer consumes fuel during taxiing, and reduces its emissions of toxic gases of the NOx and COx type.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Modifications and improvements to the implementations described above of the present invention may occur to a person skilled in the art. In particular, the embodiments and variants described can be combined provided that they are not incompatible. The above description is illustrative by means of examples rather than limiting. The scope of the present invention is therefore limited solely by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A landing gear for an aircraft, comprising:
a leg;
a wheel support;
two wheels secured to the leg by the wheel support, the two wheels being spaced apart from each other such that a space, called an internal volume, is delimited between the two wheels; and,
an electrical energy receiving device, the electrical energy receiving device comprising an electrical energy receiving element, called a receiver, configured to receive electrical energy emitted by an electrical energy emitting element, called a transmitter, the electrical energy receiving device mounted movably between a retracted position and a deployed position, in which the receiver is arranged outside the internal volume, the electrical energy receiving device comprising an end secured to the wheel support.

2. The landing gear according to claim 1, wherein the electrical energy receiving device comprises a structure for holding the receiver.

3. The landing gear according to claim 2, wherein the structure comprises a fixed part, which has an end of the electrical energy receiving device secured to the wheel support, and an articulated part on the fixed part.

4. The landing gear according to claim 3, wherein the receiver is secured to an end of the articulated part of the structure.

5. The landing gear according to claim 4, wherein the receiver is mounted movably relative to the articulated part of the structure.

6. The landing gear according to claim 1, wherein the electrical energy receiving device comprises an actuator for controlling the receiver.

7. The landing gear according to claim 1, wherein the receiver comprises an induction pad for cooperating with the transmitter in a contactless manner, or a contactor for cooperating with the transmitter by contact, or both.

8. The landing gear according to claim 1, further comprising:
an electric motor configured to control the two wheels of the landing gear of the aircraft and configured to be supplied with electrical energy via the receiver.

9. The landing gear according to claim 1, wherein the electrical energy receiving device comprises a structure for holding the receiver,
wherein the structure comprises a fixed part and an articulated part, and,
wherein the articulated part of the structure comprises two parallel arms, and at least one connecting arm that connects the two parallel arms to one another.

10. The landing gear according to claim 9, wherein each of the two parallel arms extends between a first end secured to the fixed part via an articulation and a second end secured to the receiver via an articulation.

11. The landing gear according to claim 10, wherein the end of each of the two parallel arms secured to the receiver forms an arc of a circle between a first position corresponding to a minimum value of an angle (β) and a second position corresponding to a maximum value of the angle (β), the minimum value being between 110° and 160°, and the maximum value being between 120° and 170°.

12. The landing gear according to claim 1, wherein the electrical energy receiving device comprises a structure for holding the receiver,
wherein the structure comprises a fixed part and an articulated part, and,
wherein the fixed part comprises a part resting on a wheel support and two parallel bars, which are secured by articulations to two parallel arms, an angle delimited by the fixed part and each of the two parallel bars being between a minimum value less than or equal to 90° and a maximum value greater than or equal to 90°.

13. An aircraft comprising:
the landing gear according to claim 1.

14. An electrical energy transfer system comprising:
the aircraft according to claim 13; and
an electrical energy transmitter configured to supply electrical energy to the receiver when the electrical energy receiving device is in the deployed position.
